(19) United States
(12) Patent Application Publication
(10) Pub. No.: US 2026/0212658 A1
(43) Pub. Date: Jul. 23, 2026

(54) UNSUPERVISED CHANGE DETECTION IN HYPERSPECTRAL IMAGES USING FEATURE FUSION CONVOLUTIONAL AUTOENCODER

(71) Applicant: Ashish GHOSH, Kolkata (IN)

(72) Inventors: Ashish GHOSH, Kolkata (IN); Debasrita CHAKRABORTY, Kolkata (IN); Susmita GHOSH, Kolkata (IN)

(21) Appl. No.: 19/026,824

(22) Filed: Jan. 17, 2025

(51) Int. Cl. G06V 10/82; G06V 10/25; G06V 10/74; G06V 10/762; G06V 10/764; G06V 10/774

(52) U.S. Cl. CPC G06V 10/82; G06V 10/25; G06V 10/761; G06V 10/762; G06V 10/764; G06V 10/774

(57) ABSTRACT

The present invention provides a method for unsupervised and automatic change detection in hyperspectral images comprising first of a kind Feature Fusion Convolutional AutoEncoder (FFCAE). The AutoEncoder comprises encoder and decoder wherein encoder inputs hyperspectral images for processing and decoder reverses the encoding process to reconstruct the original images. The present invention also trains the FFCAE and utilizes entropy based filtering technique to provide selected deep feature maps (Sel-DFM) which are further subjected to 2 difference operator namely, Spectral Angle Mapper (SAM) and Absolute Difference (AD). The final change detection map is generated based on K-means clustering. Hence, the method encompass various domains such as environmental monitoring, agriculture, forestry, urban planning, disaster management, and military surveillance, among others.

### FIELD OF THE INVENTION

The present invention relates to the field of image analysis. More particularly, the present invention relates to a system configured with a neural network architecture that employs first of a kind Feature Fusion Convolutional AutoEncoder (FFCAE) for unsupervised and automatic change detection in hyperspectral images.

### BACKGROUND OF THE INVENTION

Change detection in an image or video sequence comprises obtaining changes between two Hyperspectral pictures of same topographical zone taken at two unique times. It offers critical and significant change data of a scene. The purpose of change detection is to identify sections in the image or video that have changed, such as object absence or appearance, or even changes in the scene's background. Hyperspectral remote sensors can now produce images with narrow spectral resolution. Several methods have been reported for change detection in hyperspectral images. Example: Windows PCA, IRMAD, SFI-IRMAD, SFI-DSP, S3DCAE-AD and Deep SFA.

The existing prior arts disclose a method for detecting change in a pair of sequential images. The method includes training a feature descriptor based on a generated training set of matching and non-matching image pairs, but the prior art poses various challenges. The main challenge with hyperspectral images is their high dimensionality due to a large number of bands and pixel values, making conventional methods like supervised Convolutional Neural Networks (CNNs) time-consuming.

Hyperspectral images consist of hundreds of spectral bands, each containing valuable information about the observed scene. However, this high-dimensional data increases computational complexity and requires efficient techniques to reduce dimensionality while preserving essential spectral details. Handling hyperspectral data for unsupervised change detection poses several challenges due to the unique characteristics of hyperspectral imagery.

The main challenge faced by prior known methods is the high dimensionality of hyperspectral data. Yet another challenge is the handling of hyperspectral data for unsupervised change detection. Hyperspectral imaging (HSI) is a technique that analyzes a wide spectrum of light instead of just assigning primary colors (red, green, blue) to each pixel. The light striking each pixel is broken down into many different spectral bands in order to provide more information on what is imaged. Unsupervised change detection methods need to effectively capture and represent the inherent structure and variations in the hyperspectral data, which becomes increasingly challenging as the number of spectral bands increases. Additionally, hyperspectral data exhibits complex data patterns and variations.

The spectral signatures of different materials and objects can be highly similar, making it difficult to differentiate between subtle changes and noise. The noise in hyperspectral data can arise from various sources, such as atmospheric effects, sensor noise, or data acquisition conditions. Unsupervised change detection methods must be robust enough to discriminate meaningful changes from noise and accurately capture the relevant variations in the data.

Spatial information also poses a challenge in unsupervised change detection of hyperspectral data. Changes occurring at the pixel level may be influenced by neighboring pixels or exhibit spatially coherent patterns. Also, traditional unsupervised methods that focus solely on spectral information may not adequately capture the spatial context necessary for accurate change detection. Incorporating spatial information into the analysis requires specialized techniques that can effectively combine spectral and spatial features to identify meaningful changes while accounting for spatial dependencies.

Moreover, the lack of labeled data for training poses a significant challenge for unsupervised change detection. Collecting ground truth data for change detection in hyperspectral imagery is expensive, time-consuming, and often impractical. Without labeled data, unsupervised methods must rely solely on the inherent patterns and statistical properties of the data to identify changes, making the task more challenging and susceptible to false alarms or missed detections.

Thus, existing literature in the field of hyperspectral image change detection faces several limitations and challenges. One of the key issues is the inability to effectively handle the high dimensionality of hyperspectral data, which poses difficulties in computational efficiency and requires significant time, especially when a human annotator labels samples for supervised training of models. Another limitation is the lack of efficient feature extraction techniques that can capture both spatial and spectral information simultaneously. Many methods focus on either spatial or spectral features, resulting in incomplete representations. Moreover, some techniques rely on manual selection of features or thresholds, which are subjective and may not generalize well across different datasets. Additionally, existing methods often struggle with distinguishing subtle changes from noise or artifacts, leading to false positives or missed detections.

Hence, a need arises to overcome the aforementioned challenges wherein a product can demonstrate superior performance compared to other state-of-the-art methods, can handle high-dimensional data and address challenges such as under-detection and over-detection of changed pixels.

### OBJECTIVE OF THE INVENTION

The primary objective of the present inventions to provide a method for unsupervised and automatic change detection in hyperspectral images.

Another objective of the present invention is to employ convolutional layers to accurately extract both spectral and spatial information from hyperspectral images.

Another objective of the present invention is to provide an AutoEncoder for mapping different pixel values into different ranges, facilitating distinction of faulty variations (noise) from major variations (change).

Another objective of the present invention is to provide a novel approach for change detection in hyperspectral images using a Feature Fusion Convolutional Autoencoder (FFCAE).

Another objective of the present invention is to reduce the dimensions of hyperspectral images while preserving both spectral and spatial information using FFCAE.

Yet another objective of the present invention is to train the AutoEncoders wherein an unsupervised approach is adopted.

Yet another objective of the present invention is to utilize an entropy-based filtering technique.

Yet another objective of the present invention is to find the difference image (DI) between two co-registered hyperspectral images.

Yet another objective of the present invention is to provide an architecture with flexibility which allows for potential adaptations and enhancements to tackle various challenges in hyperspectral change detection.

### SUMMARY OF THE INVENTION

Accordingly, the present invention provides a method for unsupervised and automatic change detection in hyperspectral images using a AutoEncoder. The present invention comprises an end-to-end architecture of Feature Fusion Convolutional Autoencoder (FFCAE) which employs convolutional layers to extract both spectral and spatial information from the hyperspectral images, wherein FFCAE introduces a feature fusion approach whereby it employs filters of two different sizes in succession, generating lower-level features with different receptive fields. These lower-level features are concatenated and convolved to generate higher-level feature representations. The autoencoder comprises neural network architecture that consists of an encoder and a decoder and subsequently FFCAE leverages the capabilities of autoencoders to perform dimensionality reduction effectively. In the present invention, the fusion of lower-level and higher-level features occurs through a skip connection at the middle code layer, creating a balanced representation that captures both spatial and spectral information of changes. 8 layer produces compact transformed images with both spectral and spatial information of the change. Utilizing entropy-based filtering, common generic features shared by both images are discarded, leaving only discriminating features for further change analysis. Notably, the FFCAE's training efficiency is enhanced by training a single network with only two images, assuming that most pixels in unchanged images are almost identical. The proposed method outperforms other compared methods in all datasets and metrics. It effectively reduces the need for a large number of filters, preventing overfitting and suppressing small changes.

Accordingly, some exemplary suitable environments to which the present invention can be applied can include any environments where hyperspectral remote sensing data is used for change detection. This may encompass various domains such as environmental monitoring, agriculture, forestry, urban planning, disaster management, and military surveillance, among others.

### BRIEF DESCRIPTION OF DRAWINGS

The present invention will be better understood after reading the following detailed description of the presently preferred aspects with reference to the appended drawings:

FIG. 1 illustrates the complexity and richness of hyperspectral image data, which forms the basis of the change detection system of the present invention.

FIG. 2 illustrates the architecture of the proposed Feature Fusion Convolutional Autoencoder (FFCAE)

FIG. 3 illustrates the overall procedure of change detection, detailing the steps involved in the process.

FIG. 4 illustrates the comparison of result for China dataset obtained using different change detection methods. Sub-figures 4(a) to 4(h) represent the change maps generated by Windows PCA, IRMAD, SFI-IRMAD, SFI-DSP, S3DCAE-AD, Deep SFA, FFCAE-SAM, and FFCAE-AD, respectively. Subfigure 4(i) shows the ground truth for reference.

FIG. 5 illustrates the comparison of result for USA dataset obtained using different change detection methods. Sub-figures 5(a) to 5(h) represent the change maps generated by Windows PCA, IRMAD, SFI-IRMAD, SFI-DSP, S3DCAE-AD, Deep SFA, FFCAE-SAM, and FFCAE-AD, respectively. Subfigure 5(i) shows the ground truth for reference.

FIG. 6 illustrates the comparison of result for River dataset obtained using different change detection methods. Sub-figures 6(a) to 6(h) represent the change maps generated by Windows PCA, IRMAD, SFI-IRMAD, SFI-DSP, S3DCAE-AD, Deep SFA, FFCAE-SAM, and FFCAE-AD, respectively. Subfigure 6(i) shows the ground truth for reference.

FIG. 7 illustrates the comparison of result for Hermiston dataset obtained using different change detection methods. Sub-figures 7(a) to 7(h) represent the change maps generated by Windows PCA, IRMAD, SFI-IRMAD, SFI-DSP, S3DCAE-AD, Deep SFA, FFCAE-SAM, and FFCAE-AD, respectively. Subfigure 7(i) shows the ground truth for reference.

Other objects and advantages of the present invention will become apparent from the following description taken in connection with the accompanying drawings, wherein, by way of illustration and example, the aspects of the present invention are disclosed.

### DETAILED DESCRIPTION OF THE INVENTION

The following description describes various features and functions of the disclosed system and apparatus. The illustrative aspects described herein are not meant to be limiting. It may be readily understood that certain aspects of the disclosed system and apparatus can be arranged and combined in a wide variety of different configurations, all of which are contemplated herein.

The following description of preferred embodiments of the invention is not intended to limit the invention to these preferred embodiments, but rather to enable any person skilled in the art to make and use this invention.

These and other features and advantages of the present invention may be incorporated into certain embodiments of the invention and will become more fully apparent from the following description as set forth hereinafter.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention are provided for illustration purpose only and not for the purpose of limiting the invention.

It is to be understood that the singular forms “a,” “an,” and “the” include plural referents unless the context clearly dictates otherwise.

It should be emphasized that the term “comprises/comprising” when used in this specification is taken to specify the presence of stated features, integers, steps or components but does not preclude the presence or addition of one or more other features, integers, steps, components or groups thereof.

The term ‘unsupervised’ herein refers to direct learning from the given examples, i.e. unlabeled dataset, in contrary to supervised learning, wherein learning is from the previous examples given. The dataset for the supervised learning is labeled.

The present invention provides a method for unsupervised change detection in hyperspectral images comprising a first of a kind Feature Fusion Convolutional AutoEncoder (FFCAE). The present invention comprises an end-to-end architecture of Feature Fusion Convolutional Autoencoder (FFCAE) which employs convolutional layers to extract both spectral and spatial information from the hyperspectral images, wherein FFCAE introduces a feature fusion approach whereby it employs filters of two different sizes in succession, generating lower-level features with different receptive fields. These lower-level features are concatenated and convolved to generate higher-level feature representations. The fusion of lower-level and higher-level features occurs through a skip connection at the middle code layer, creating a balanced representation that captures both spatial and spectral information of changes.

Accordingly, the present invention provides a system for unsupervised change detection in hyperspectral images, comprising:
a Feature Fusion Convolutional Autoencoder (FFCAE) comprising a plurality of convolutional layers with twin filters to capture spectral and spatial information from bi-temporal co-registered hyperspectral image pairs (I₁ and I₂);
a difference operator to compare the extracted features of the bi-temporal hyperspectral images;
a decision function (g( )) to classify changed and unchanged regions based on the differences obtained from the FFCAE; and
an unsupervised training module for training FFCAE utilising backpropagation to minimize the error of reconstruction wherein the FFCAE employs an end-to-end architecture for automatic feature extraction.

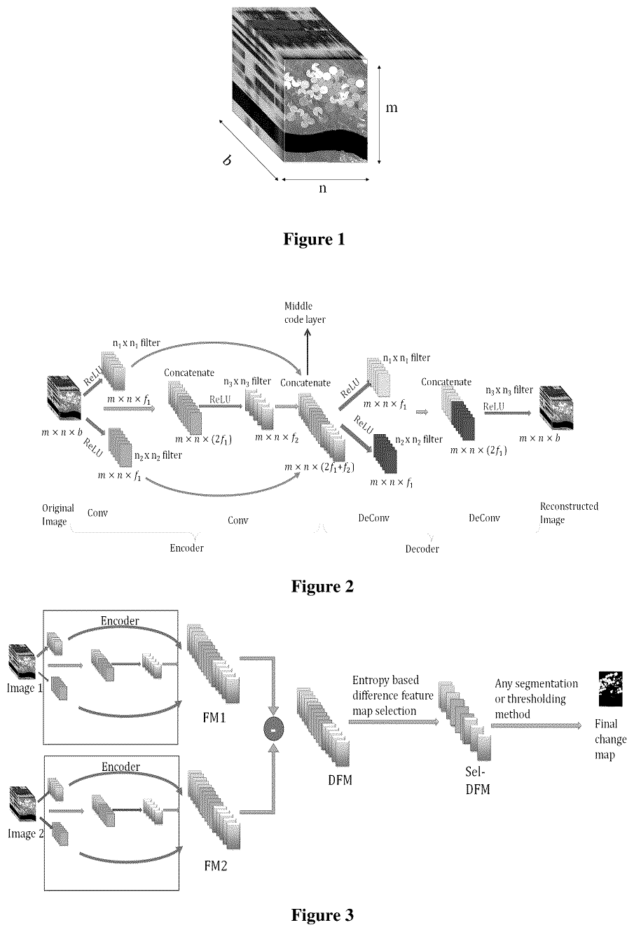

In an exemplary embodiment of the present invention, FIG. 1 illustrates the complexity and richness of hyperspectral image data, showcasing the foundation on which the change detection system of the present invention is built. Accordingly, hyperspectral images capture a vast amount of information about a scene by acquiring data in numerous narrow and contiguous spectral bands. Each band represents a specific wavelength of light, providing a detailed spectral signature for every pixel in the image. As a result, hyperspectral images can reveal valuable insights about the composition and characteristics of the observed area, making them valuable tools in various applications, such as environmental monitoring, agriculture, mineral exploration, and land-use classification.

In the present invention, the change detection system utilizes Feature Fusion Convolutional Autoencoder (FFCAE) to address the challenges posed by hyperspectral image data. The FFCAE is an end-to-end architecture designed to efficiently extract informative features and accurately detect changes in the hyperspectral images. It leverages the capabilities of AutoEncoders to perform dimensionality reduction effectively and combines lower-level and higher-level features through skip connections to achieve a balanced representation of spatial and spectral information.

In an embodiment, at the core of the FFCAE is the autoencoder, a neural network architecture that consists of an encoder and a decoder. The encoder maps the input hyperspectral image to a lower-dimensional code representation, whereas the decoder reconstructs the original image from this code. The AutoEncoder learns to extract meaningful features that capture the essential information of the input image. In the FFCAE, the original hyperspectral image is convolved with filters of two different sizes successively, generating lower-level features with different receptive fields. These features are concatenated and convolved with another filter to generate a higher-level feature representation. Both the lower-level and higher-level features are then concatenated with a skip connection at the next level (middle code layer), facilitating feature fusion.

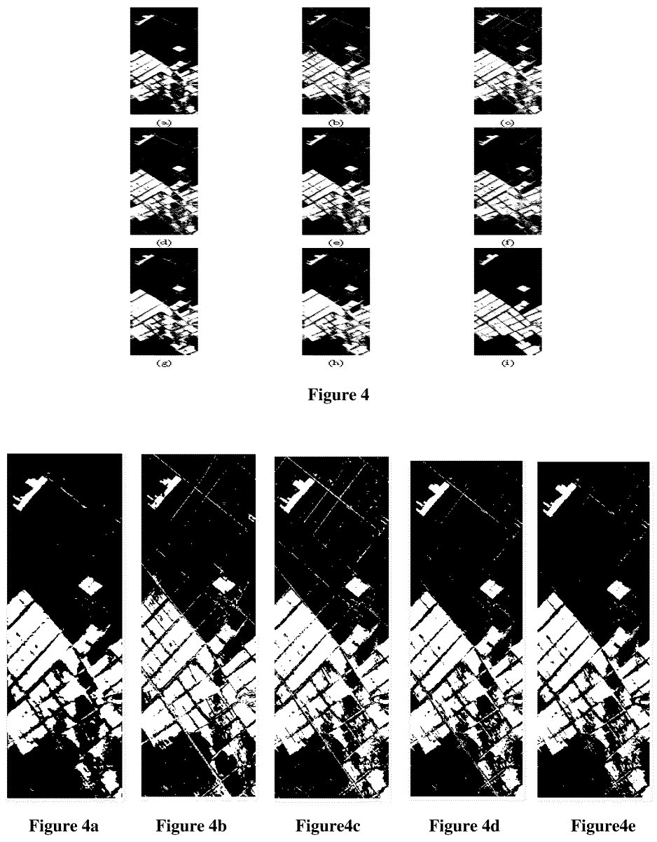

In an embodiment, FIG. 2 depicts the architecture of the Feature Fusion Convolutional Autoencoder (FFCAE), which forms the basis of the change detection system in the present invention. The FFCAE is designed to efficiently extract informative features from hyperspectral images and facilitate the detection of changes between two images. Blue arrows indicate the trainable weights, which play a crucial role in the network's ability to learn and adapt to the given data.

The present invention also provides a method for unsupervised change detection in hyperspectral images using the FFCAE, comprising the steps of:
a. receiving a pair of bi-temporal co-registered hyperspectral images.
b. employing the FFCAE to extract deep spectral and spatial features from the pair of hyperspectral images.
c. utilizing the difference operator to compare the extracted features and obtain a change detection map.
d. applying post-processing techniques, such as entropy-based filtering, to the change map for further refinement.
e. finding the changed pixels by clustering or thresholding the change map.

Firstly, the input image is processed through the encoder, it goes through filters of two different sizes successively, creating lower-level features with distinct receptive fields. These lower-level features are then concatenated and processed through another filter to generate higher-level feature representations. The process of feature fusion is facilitated through skip connections, where both the lower-level and higher-level features are concatenated at the middle code layer. This feature fusion mechanism helps combine spatial and spectral information effectively, enhancing the network's ability to identify changes accurately. The decoder part of the FFCAE reverses the encoding process and reconstructs the original image from the extracted features. The trainable weights in the decoder play a crucial role in learning to reconstruct the input image accurately.

During the training phase, the FFCAE learns by the technique of backpropagation. In an exemplary embodiment, Adam optimizer is utilized to adjust the weights in a way that minimizes the Mean Squared Error. It ensures that the network learns to reconstruct inputs with minimal errors and retains relevant information.

The overall approach comprises finding the difference image (DI) between two co-registered hyperspectral images, denoted as Image 1 and Image 2 (I₁ and I₂). Each pixel in the hyperspectral images, represented by pᵢⱼ, is a vector of b dimensions, where b is the number of bands in the images. The DI is generated by computing the element-wise absolute difference between the corresponding bands of the two images, resulting in a new image representing the changes that have occurred between the two time points. This DI is then thresholded or clustered to create a binary change map C.

The binary change map C is of the same size as the input hyperspectral images, where each pixel cᵢⱼ in C is assigned a value of one if the location represented by

$${p}_{ij}^{{I}_{1}}$$

### in I₁ and

$${p}_{ij}^{{I}_{2}}$$

in I₂ has changed. Otherwise, cᵢⱼ is set to zero if no change is detected at that location. The generation of the change map can be mathematically represented as follows:
i. Compute the feature transformation of the hyperspectral images:

$${F}_{1} = f ( {I}_{1} ) and {F}_{2} = f ( {I}_{2} ) .$$

ii. Calculate the difference between the feature-transformed images:

$$D = {F}_{1} Θ {F}_{2} ,$$

where Θ represents the element-wise difference operation.
iii. Apply the decision function g( ) to the difference image D to generate the binary change map C,

$$C = g ( D ) .$$

The feature transformation function ƒ( ) extracts relevant information from the input hyperspectral images, and the decision function g( ) classifies the changes based on the computed differences. The resulting change map C highlights the locations where changes have occurred between the two time points.

The choice of filter sizes in the FFCAE is crucial, it determines the receptive field and the ability to capture spatial contextual information. Twin filters of size 3×3 and 5×5 are employed, striking a balance between capturing spatial details and avoiding overfitting. The middle code layer of the FFCAE produces the most compact transformed image, preserving both spatial and spectral information related to the changes in the scene. The use of skip connections ensures that the features from different levels are combined, further enhancing the ability to identify changes accurately. Skip connections, also known as residual connections, refers to the direct connections between layers that skip one or more layers. The skip connections aims to address the vanishing gradient problem and facilitates the flow of gradients during training. These connections contribute to the network's ability to accurately identify changes in the scene by combining features from various stages of the transformation process.

In an embodiment of the present invention, in order to train the FFCAE, an unsupervised approach is adopted, where the network is trained on pairs of hyperspectral images without any labeled ground truth. The autoencoder learns to reconstruct the input images, capturing common generic features shared between the two images. However, discriminative features related to the changes are mapped into separate feature maps, which are identified using an entropy-based filtering technique. The selected deep feature maps are then utilized for further change analysis, effectively distinguishing between changed and unchanged pixels.

The image capturing process involves satellites capturing hyperspectral images of the target area. These images may consist of hundreds or even thousands of spectral bands, making them highly detailed and information rich. After capturing, the images need to be co-registered to ensure precise alignment and accurate comparison between the two images. Co-registration software, which is not part of the scope of the invention presented here, can be used for this purpose.

Once the images are co-registered, the user can upload them to the server. The server should be equipped with a backend code that includes the trained FFCAE model and the necessary functions for image preprocessing, feature extraction, and change detection. Upon receiving the uploaded images, the server backend preprocesses the images to ensure they are in the correct format and compatible with the FFCAE model. The images are then fed into the FFCAE, which automatically extracts deep feature maps representing the relevant spatial and spectral information. The backend code interacts with the FFCAE model to process the uploaded images and extract deep feature maps using the trained network. The unsupervised nature of the FFCAE allows it to identify common generic features shared between the two images and discriminate between changed and unchanged pixels.

After the change detection process is completed, the backend code generates the change map, highlighting the regions in the images where changes have been detected. The change map can be visualized and presented to the user through the front-end interface, providing an intuitive display of the detected changes.

The server hosting the change detection system should have an ample amount of Random Access Memory (RAM) to handle the large datasets efficiently. The hyperspectral images can be memory-intensive, especially when processing multiple bands and large spatial dimensions. A sufficient amount of RAM allows the server to store and manipulate the data in memory, reducing the need for frequent read/write operations to disk and thereby speeding up the processing.

In an exemplary embodiment of the present invention, Python, along with deep learning libraries like TensorFlow or PyTorch, can be used to implement the backend code. A web application framework like Flask or Django can be utilized for the front-end interface, allowing users to upload their co-registered hyperspectral image pairs and access the change detection results through API calls. This setup ensures efficient processing, accurate results, and a seamless user experience.

After the entropy-based filtering in the change detection framework, the remaining selected deep feature maps (Sel-DFM) can be subjected to any difference operator. In an embodiment, two methods have been explored: Spectral Angle Mapper (SAM) and Absolute Difference (AD). SAM is a spectral matching technique that measures the spectral similarity between corresponding pixels in the two input hyperspectral images. It computes the angle between the two vectors representing the spectral signatures of the pixels and is effective in detecting subtle spectral changes. On the other hand, the AD method simply calculates the absolute pixel-wise difference between the selected feature maps of the two images. This method is sensitive to even minor changes in pixel values and can effectively highlight spatial changes in the scene.

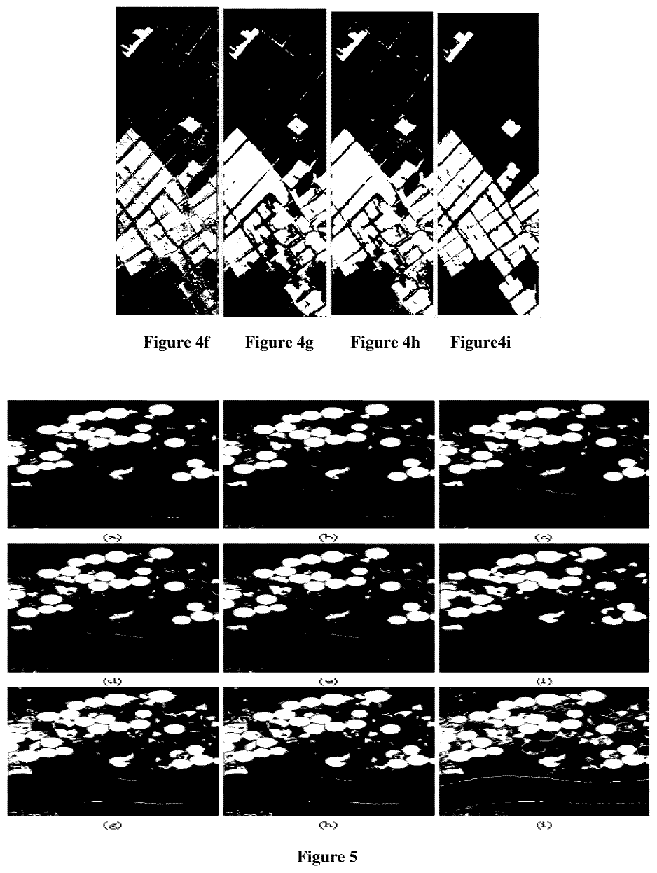

FIG. 3 illustrates the overall procedure of change detection in the proposed embodiment of the invention. The process involves several key steps to identify changes between two input hyperspectral images. Initially, the images are preprocessed and co-registered using co-registration software, which may be performed by the user separately. The co-registered images are then uploaded to the server, where the backend code of the invention is hosted. The FFCAE, an end-to-end architecture with unique features, is utilized for feature extraction. The FFCAE reduces the dimensions of the hyperspectral images while preserving important spectral and spatial information. The middle code layer of the FFCAE provides extracted features (DFM).

$${DFM}_{1} = f ( {I}_{1} ) and {DFM}_{2} = f ( {I}_{2} )$$

Following the feature extraction, entropy-based filtering is applied to select the most relevant and discriminative deep feature maps (denoted as Sel-DFM). The feature maps for which the entropy of the difference is zero, are discarded.

Accordingly, either the Spectral Angle Mapper (SAM) or the Absolute Difference (AD) method is employed afterwards to compute change maps based on the selected deep feature maps. SAM measures the spectral similarity between corresponding pixels in the two images, whereas AD calculates the absolute pixel-wise differences between the feature maps. The choice of image difference method is not particularly limited. In an alternative embodiment of the present invention, any other image difference method may also be used to determine the changes in pixel of the two images.

The final change detection map is generated based on the K-means clustering results, classifying each pixel as changed or unchanged. By combining the feature extraction capabilities of FFCAE and the discriminative power of either SAM or AD with K-means clustering, the proposed system achieves accurate and reliable change detection in complex hyperspectral images.

In an embodiment, the network's size is designed to handle the complexity and richness of hyperspectral image data effectively. The architecture of the present invention may be adapted according to the size, number of filters in the convolutional layers and skip connections to create a fusion of lower-level and higher-level features. The FFCAE is flexible and can accommodate various input image dimensions. However, larger input image sizes may require more memory and computational resources, potentially increasing the training time.

In an embodiment, the present invention may include a computer program product that may comprise computer-readable instructions for causing a processor to carry out aspects of the present invention on a computer or a processing device.

### EXAMPLES

The present invention may be clearly understood from the following exemplary embodiments. The examples hereinbelow are the mere embodiments and should not be construed to limit the scope of the present invention.

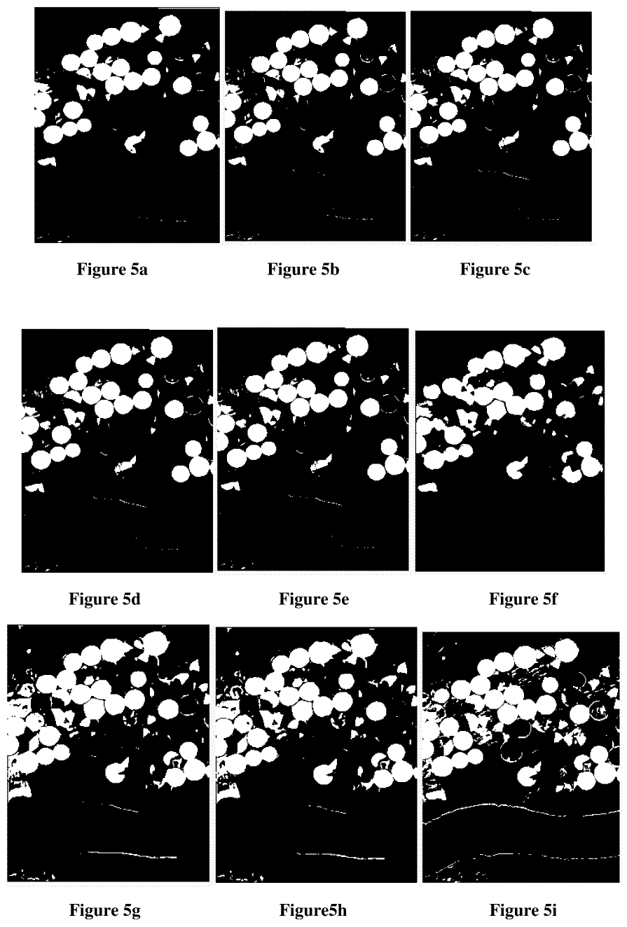

FIG. 4 illustrates an exemplary embodiment which highlights the method for performing unsupervised change detection. The method comprises the following steps:
1. Preprocessing and co-registering hyperspectral image pair.
2. Pretraining two identical FFCAEs on each image for feature extraction of each image in the middle code layer.
3. Discarding the decoders of each FFCAE and taking feature maps (DFM) generated in the middle code layers of each.
4. Applying entropy-based filtering on each of the image's obtained DFMs for informative feature maps (Sel-DFM).
5. Generating binary change map using difference method (for example, SAM, AD, etc.)

6. Applying thresholding or clustering (k-means) to separate changed and unchanged pixels.

The model is trained using an optimization algorithm such as but not limited to Adam optimizer with a learning rate of e⁻³. The value of k in k-means is chosen as 2 as the context is to differentiate between changed and unchanged pixels (and hence two categories only).

In an exemplary embodiment, the FFCAE architecture is implemented with versatility in mind The architecture ensures compatibility with various hardware configurations and deep learning frameworks. The FFCAE architecture, in an exemplary implementation, leverages the parallel processing capabilities of the NVIDIA RTX A5500 GPU. The choice of NVIDIA RTX A5500 GPU enhances the computational efficiency of the training and inference processes. The architecture is designed with flexibility, allowing implementation on CPU and TPU architectures, ensuring accessibility across a range of computing devices. The FFCAE is also implemented utilizing the Keras framework with a Tensorflow backend, capitalizing on the high-level abstractions for neural network design and the robust computing capabilities provided by Tensorflow. The FFCAE architecture recognizes the diverse preferences in deep learning community and seamlessly adapted for implementation using the PyTorch framework.

Hence, the FFCAE architecture is flexible. This flexibility enables researchers and practitioners to leverage the advantages of both Keras/Tensorflow and PyTorch ecosystems. The FFCAE is implemented in Python 3.10, it provides a rich ecosystem of libraries and frameworks for efficient development, experimentation, and deployment. The implementation of Keras/Tensorflow and PyTorch ecosystems utilizes key open-source libraries such as Scikit-learn for machine learning utilities, Numpy for numerical operations, Pandas for data manipulation, Pillow for image processing, and OpenCV for computer vision tasks.

The FFCAE is designed to scale efficiently, accommodating datasets of varying sizes and complexities. The architecture can also harness parallel processing capabilities, optimizing performance during both training and inference stages.

The performance of the change detection system may be evaluated in terms of the (i) overall accuracy (OA), (ii) Cohen's kappa measure (x), (iii) ƒ-score, percentage of wrong classification (PWC), and (iv) Detection Rate (DR).

Four hyperspectral image pair datasets have been chosen, namely, China, USA, River, Hermiston.

### Example 1: China

In the China dataset, the change detection performance of various methods is evaluated using different metrics as shown in Table 1.

TABLE 1
Quantitative results on China Dataset

| | | Kappa | | | |
|---|---|---|---|---|---|
| Models | OA | measure | f-score | PWC | DR |
| Windows PCA | 0.8688 | 0.6801 | 0.8429 | 13.1241 | 0.7673 |
| IRMAD | 0.8659 | 0.6801 | 0.8408 | 13.415 | 0.7864 |
| SFI-IRMAD | 0.8784 | 0.7165 | 0.8583 | 12.1582 | 0.8284 |
| SFI-DSP | 0.8817 | 0.7168 | 0.8595 | 11.8316 | 0.802 |
| S3DCAE-AD | 0.8885 | 0.7333 | 0.8677 | 11.1463 | 0.8108 |
| Deep SFA | 0.892 | 0.7419 | 0.8719 | 10.801 | 0.8166 |
| FFCAE-SAM | 0.8934 | 0.7489 | 0.8746 | 10.665 | 0.836 |
| FFCAE-AD | 0.8956 | 0.7604 | 0.8804 | 10.4422 | 0.8725 |

For the Overall Accuracy (OA), among the traditional unsupervised methods, SFI-IRMAD achieves an OA of 87.84%, followed by SFI-DSP with an OA of 88.17%. The deep learning-based method S3DCAE-AD achieves an OA of 88.85%, while Deep SFA outperforms others with an OA of 89.20%. Notably, both proposed variants of the Feature Fusion Convolutional Autoencoder (FFCAE) surpass all other methods in terms of OA, with FFCAE-SAM achieving 89.34%, and FFCAE-AD achieving the highest OA of 89.56%.

In terms of Cohen's kappa measure, FFCAE-SAM and FFCAE-AD also outperform other methods, achieving 0.7489 and 0.7604, respectively, compared to the best score of 0.7419 achieved by Deep SFA.

The ƒ-score metric, which combines precision and recall, is critical for evaluating the performance of change detection. Again, both FFCAE-SAM and FFCAE-AD exhibit the highest ƒ-score values of 0.8746 and 0.8804, respectively, outperforming the best ƒ-score of 0.8719 achieved by Deep SFA.

For the percentage of wrong classification (PWC), FFCAE-SAM and FFCAE-AD achieve lower values of 10.6650% and 10.4422%, respectively, compared to the best PWC of 10.8010% achieved by Deep SFA.

Finally, in terms of Detection Rate (DR), FFCAE-SAM attains an impressive value of 0.8360, and FFCAE-AD surpasses all other methods with a DR of 0.8725, compared to the best DR of 0.8284 achieved by SFI-IRMAD.

Also, FIG. 4 illustrates the comparison of result for China obtained using different change detection methods. Sub-figures 4(a) to 4(h) represent the change maps generated by Windows PCA, IRMAD, SFI-IRMAD, SFI-DSP, S3DCAE-AD, Deep SFA, FFCAE-SAM, and FFCAE-AD, respectively. Subfigure 4(i) shows the ground truth for reference

### Example 2: USA

In the USA dataset, the system demonstrates superior performance compared to the state-of-the-art methods as shown in Table 2.

TABLE 2
Quantitative results on USA Dataset

| Models | OA | κ | f-score | PWC | DR |
|---|---|---|---|---|---|
| Windows PCA | 0.9106 | 0.7111 | 0.8662 | 8.9435 | 0.8182 |
| IRMAD | 0.9217 | 0.7471 | 0.8847 | 7.8298 | 0.8303 |
| SFI-IRMAD | 0.923 | 0.7518 | 0.8868 | 7.6959 | 0.8325 |
| SFI-DSP | 0.9228 | 0.7508 | 0.8863 | 7.723 | 0.8319 |
| S3DCAE-AD | 0.9229 | 0.7511 | 0.8865 | 7.7135 | 0.8321 |
| Deep SFA | 0.9317 | 0.7867 | 0.899 | 6.8323 | 0.8592 |
| FFCAE-SAM | 0.9462 | 0.8421 | 0.9215 | 5.378 | 0.9143 |
| FFCAE-AD | 0.9447 | 0.836 | 0.9189 | 5.5321 | 0.9057 |

For the Overall Accuracy (OA), FFCAE-SAM achieves the highest score of 94.62%, outperforming other methods, including Deep SFA (93.17%) and SFI-IRMAD (92.30%). However, FFCAE-AD also performs remarkably well, obtaining an OA of 94.47%, which is only slightly lower than FFCAE-SAM.

Similarly, for Cohen's kappa measure, FFCAE-SAM achieves the highest score of 0.8421, surpassing Deep SFA (0.7867) and SFI-IRMAD (0.7518). Again, FFCAE-AD closely follows with a k value of 0.8360.

For the ƒ-score metric, FFCAE-SAM demonstrates the best performance, obtaining a score of 0.9215, which outperforms Deep SFA (0.8990) and SFI-IRMAD (0.8868). FFCAE-AD also shows competitive results, with an ƒ-score of 0.9189.

Regarding the Percentage of Wrong Classification (PWC), FFCAE-SAM achieves the lowest value of 5.3780%, indicating better accuracy in distinguishing changed and unchanged pixels compared to other methods. Although FFCAE-AD shows a slightly higher PWC of 5.5321%, it still performs favorably compared to the state-of-the-art methods.

Lastly, for the Detection Rate (DR), FFCAE-SAM again exhibits the highest value of 0.9143, surpassing Deep SFA (0.8592) and SFI-IRMAD (0.8325). FFCAE-AD demonstrates a competitive DR of 0.9057.

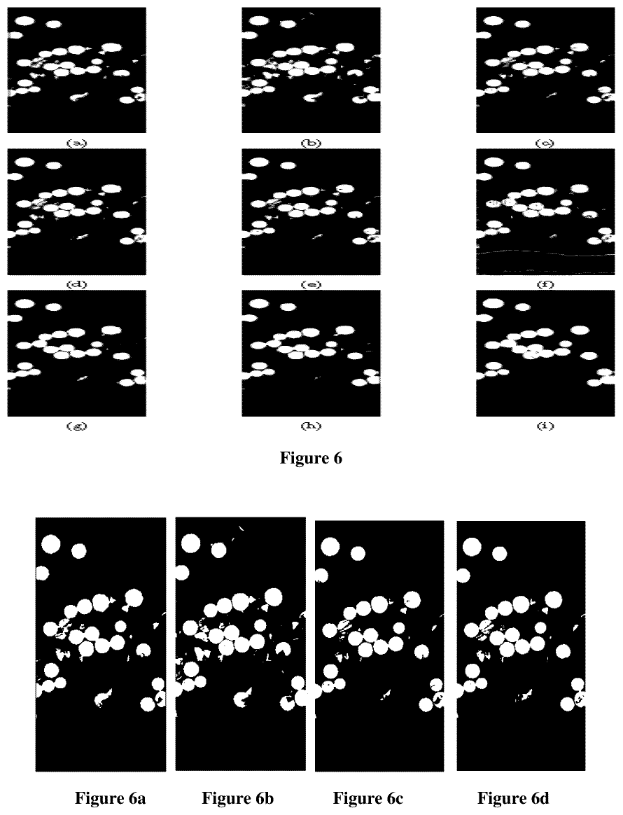

Also, FIG. 5 illustrates the comparison of result for USA obtained using different change detection methods. Sub-figures 5(a) to 5(h) represent the change maps generated by Windows PCA, IRMAD, SFI-IRMAD, SFI-DSP, S3DCAE-AD, Deep SFA, FFCAE-SAM, and FFCAE-AD, respectively. Subfigure 5(i) shows the ground truth for reference.

### Example 3: River

For the River dataset, the results of the change detection system are presented in Table 3.

TABLE 3
Quantitative results on River Dataset

| Models | OA | κ | f-score | PWC | DR |
|---|---|---|---|---|---|
| Windows PCA | 0.8863 | 0.4879 | 0.763 | 11.3736 | 0.9562 |
| IRMAD | 0.9401 | 0.5663 | 0.7888 | 5.992 | 0.9116 |
| SFI-IRMAD | 0.9415 | 0.5311 | 0.7846 | 5.853 | 0.8984 |
| SFI-DSP | 0.9491 | 0.6464 | 0.8261 | 5.0886 | 0.9274 |
| S3DCAE-AD | 0.942 | 0.5535 | 0.7896 | 5.7966 | 0.9044 |
| Deep SFA | 0.9461 | 0.6645 | 0.8323 | 5.3933 | 0.9443 |
| FFCAE-SAM | 0.9584 | 0.7454 | 0.873 | 4.1646 | 0.961 |
| FFCAE-AD | 0.9604 | 0.7436 | 0.872 | 3.963 | 0.9519 |

Among the state-of-the-art methods, SFI-IRMAD achieved the highest overall accuracy (OA) of 94.15%, followed closely by SFI-DSP with 94.91% OA. However, FFCAE-SAM outperformed all other methods and achieved the highest OA of 95.84%, indicating its effectiveness in accurately identifying changes in the hyperspectral images. Similar trends are observed in other performance metrics as well.

For Cohen's kappa measure, SFI-DSP had the highest score of 0.6464, while FFCAE-SAM surpassed all other methods with a score of 0.7454.

The ƒ-score for SFI-DSP was the highest among the state-of-the-art methods at 0.8261, but FFCAE-SAM and FFCAE-AD obtained even higher scores of 0.8730 and 0.8720, respectively.

In terms of percentage of wrong classification (PWC), FFCAE-AD demonstrated the best performance with the lowest value of 3.9630%, followed closely by FFCAE-SAM with 4.1646%.

Lastly, the Detection Rate (DR) for FFCAE-SAM was the highest at 96.10%, indicating its superior ability to detect true changes in the imagery.

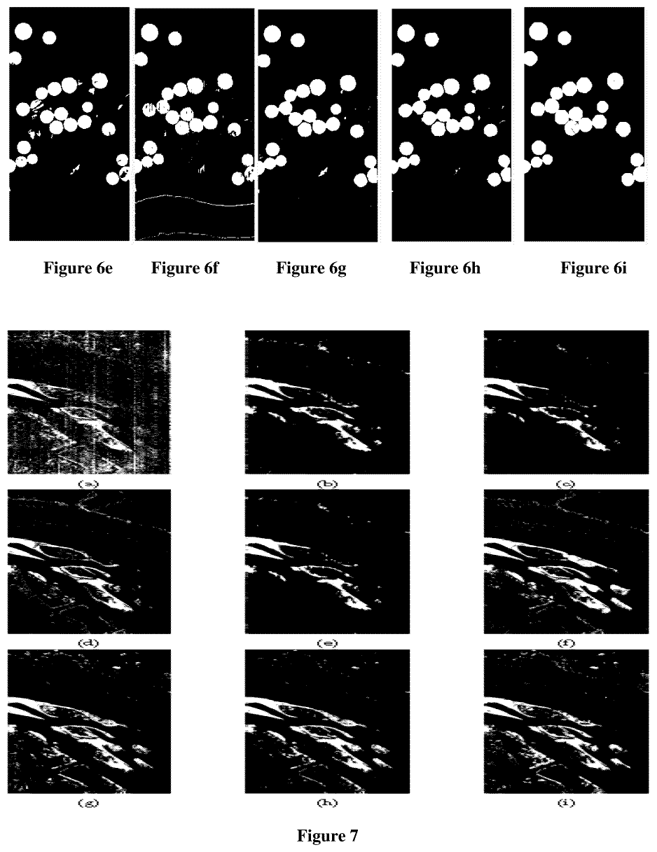

Also, FIG. 6 illustrates the comparison of results for River obtained using different change detection methods. Sub-figures 6(a) to 6(h) represent the change maps generated by Windows PCA, IRMAD, SFI-IRMAD, SFI-DSP, S3DCAE-AD, Deep SFA, FFCAE-SAM, and FFCAE-AD, respectively. Subfigure 6(i) shows the ground truth for reference.

### Example 4: Hermiston

For the Hermiston dataset, the proposed FFCAE-based change detection models, FFCAE-SAM and FFCAE-AD, achieve outstanding performance, outperforming all other state-of-the-art methods as shown in Table 4.

TABLE 4
Quantitative results on Hermiston Dataset

| Models | OA | κ | f-score | PWC | DR |
|---|---|---|---|---|---|
| Windows PCA | 0.967 | 0.8503 | 0.9252 | 3.3013 | 0.9584 |
| IRMAD | 0.9618 | 0.8348 | 0.9178 | 3.8154 | 0.9679 |
| SFI-IRMAD | 0.9751 | 0.8837 | 0.9426 | 2.4936 | 0.9588 |
| SFI-DSP | 0.9752 | 0.8872 | 0.9437 | 2.4795 | 0.9666 |
| S3DCAE-AD | 0.9751 | 0.8842 | 0.9427 | 2.4872 | 0.9594 |
| Deep SFA | 0.9742 | 0.8833 | 0.9417 | 2.5795 | 0.9674 |
| FFCAE-SAM | 0.9812 | 0.9145 | 0.9574 | 1.8756 | 0.9727 |
| FFCAE-AD | 0.9819 | 0.9176 | 0.9589 | 1.8051 | 0.973 |

In terms of overall accuracy (OA), FFCAE-SAM achieves a remarkable score of 98.12%, while FFCAE-AD performs even better with an OA score of 98.19%. In comparison, the best OA score achieved by other models, SFI-IRMAD and SFI-DSP, is 97.51% and 97.52%, respectively.

Similarly, for Cohen's kappa measure, the FFCAE-AD model achieves the highest score of 0.9176, while FFCAE-SAM follows closely with a score of 0.9145. The highest score achieved by other models, such as S3DCAE-AD and Deep SFA, is 0.8842 and 0.8833, respectively. The proposed FFCAE models also demonstrate exceptional performance in terms of the ƒ-score metric. FFCAE-AD achieves the best ƒ-score of 0.9589, closely followed by FFCAE-SAM with a score of 0.9574. On the other hand, the highest ƒ-score achieved by other models, such as SFI-IRMAD and Deep SFA, is 0.9426 and 0.9417, respectively.

For the percentage of wrong classification (PWC), the FFCAE-AD model exhibits a significantly lower value of 1.8051%, whereas FFCAE-SAM also performs remarkably well with a PWC of 1.8756%. In comparison, other models such as SFI-IRMAD and SFI-DSP have higher PWC values of 2.4936% and 2.4795%, respectively.

Lastly, for the Detection Rate (DR), both FFCAE-SAM and FFCAE-AD achieve outstanding performance with scores of 0.9727 and 0.9730, respectively. The highest DR score achieved by other models, SFI-DSP and Deep SFA, is 0.9666 and 0.9674, respectively.

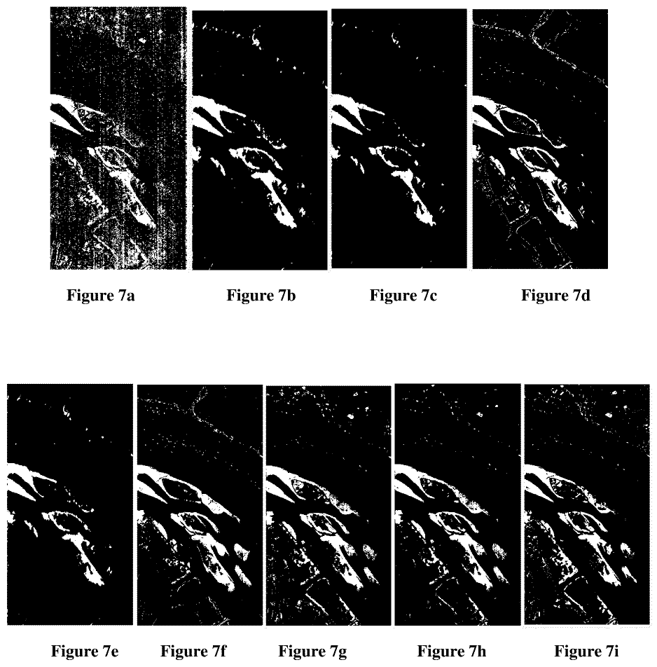

Also, FIG. 7 illustrates the comparison of result for Hermiston obtained using different change detection methods. Sub-figures 7(a) to 7(h) represent the change maps generated by Windows PCA, IRMAD, SFI-IRMAD, SFI-DSP, S3DCAE-AD, Deep SFA, FFCAE-SAM, and FFCAE-AD, respectively. Subfigure 7(i) shows the ground truth for reference.

### Advantages of the Invention

Although the embodiments herein are described with various specific embodiments, it will be obvious for a person skilled in the art to practice the invention with modifications. However, all such modifications are deemed to be within the scope of the invention.

The present invention is applied to unsupervised change detection in various hyperspectral datasets. The proposed FFCAE demonstrates superior performance compared to other state-of-the-art methods, addressing challenges such as under-detection and over-detection of changed pixels. The method successfully identifies both minor and significant changes simultaneously without relying on label information, making it well-suited for unsupervised scenarios.

Furthermore, the present invention is not limited solely to unsupervised change detection. It may be adapted to supervised or semi-supervised settings by incorporating labeled data during the training process. Additionally, the FFCAE's feature extraction capabilities can be explored in multi-class change detection scenarios, where the goal is to identify changes across multiple classes over time.

The implementation of the FFCAE in the present invention offers several advantages, including reduced computational time compared to supervised convolutional networks and effective feature extraction for improved change detection. The architecture's flexibility allows for potential adaptations and enhancements to tackle various challenges in hyperspectral change detection, making it a promising approach in the field of remote sensing and environmental monitoring.

Accordingly, some exemplary suitable environments to which the present invention can be applied can include any environments where hyperspectral remote sensing data is used for change detection. This may encompass various domains such as environmental monitoring, agriculture, forestry, urban planning, disaster management, and military surveillance, among others.

In environmental monitoring, the invention can be utilized to detect changes in natural landscapes, water bodies, and vegetation cover.

In agriculture, it can aid in monitoring crop health and identifying changes in crop patterns. In forestry, the invention can be employed to track deforestation or forest regrowth.

In urban planning, it can assist in monitoring urban sprawl and infrastructure changes. During disaster management, the invention can be applied to assess damages caused by natural disasters.

Having described preferred embodiments of the change detection system and method (which are intended to be illustrative and not limiting), it is important to note that various modifications and variations can be made by individuals skilled in the art in light of the above teachings. Therefore, it is understood that changes may be made in the specific embodiments disclosed herein that are within the scope and spirit of the invention as outlined by the appended claims. Having thus presented aspects of the invention with the necessary details and particularity required by the patent laws, what is claimed and desired to be protected by Letters Patent is set forth in the appended claims.

1. A change detection system for unsupervised change detection in hyperspectral images, comprising:
a Feature Fusion Convolutional Autoencoder (FFCAE) comprising a plurality of convolutional layers with twin filters to capture spectral and spatial information from bi-temporal co-registered hyperspectral image pairs;
a difference operator to compare the extracted features of the bi-temporal hyperspectral images
a decision function (g( )) to classify changed and unchanged regions based on the differences obtained from the FFCAE; and
an unsupervised training module for training FFCAE utilising backpropagation to minimize the error of reconstruction wherein the FFCAE employs an end-to-end architecture for automatic feature extraction.

2. The change detection system of claim 1, wherein the Feature Fusion Convolutional Autoencoder (FFCAE) consists of
a. an encoder configured to map the input hyperspectral image to a lower-dimensional code representation;
b. a decoder configured to reconstruct the original image from the lower-dimensional code; and
c. a middle code layer.

3. The change detection system of claim 2, wherein the autoencoder consists of a first filter and a second filter, wherein the first filter creates lower-level features with distinct receptive fields which are then concatenated, convolved and processed through the second filter to generate higher-level feature representations.

4. The change detection system of claim 1, wherein the difference operator is selected from absolute difference (AD) or Spectral Angle Mapper (SAM).

5. The change detection system of claim 1, wherein a feature transformation function extracts relevant information from the input hyperspectral images, and the decision function classifies the changes based on the computed differences.

6. A computer-implemented method for unsupervised change detection in hyperspectral images using the FFCAE, comprising the steps of:
a. receiving a pair of bi-temporal co-registered hyperspectral images.
b. employing the FFCAE to extract deep spectral and spatial features from the pair of hyperspectral images.
c. utilizing the difference operator to compare the extracted features and obtain a change detection map.
d. applying post-processing techniques, such as entropy-based filtering, to the change map for further refinement.
e. finding the changed pixels by clustering or thresholding the change map.

7. The computer-implemented method of claim 6, wherein the lower-level and higher-level features are then concatenated with a skip connection at the next level (middle code layer), facilitating feature fusion.

8. The computer-implemented method of claim 6, wherein the difference operator Spectral Angle Mapper (SAM) measures spectral similarity between corresponding pixels in the two input hyperspectral images and computes angle between the two vectors representing the spectral signatures of the pixels.

9. The computer-implemented method of claim 6, wherein the difference operator Absolute Difference (AD) calculates the absolute pixel-wise difference between the selected feature maps of the two images

10. The computer-implemented method of claim 6, wherein the change detection map is generated based on the K-means clustering results, classifying each pixel as changed or unchanged.

11. A computer program product comprising computer-readable instructions for implementing the method of claim 6 on a computer or processing device.
